(19) United States
(12) Patent Application Publication
(10) Pub. No.: US 2023/0009708 A1
(43) Pub. Date: Jan. 12, 2023

(54) SEALING DEVICE

(71) Applicant: UCHIYAMA MANUFACTURING CORP., Okayama (JP)

(72) Inventor: Kenta EMI, Okayama (JP)

(21) Appl. No.: 17/862,067

(22) Filed: Jul. 11, 2022

(30) Foreign Application Priority Data
Jul. 12, 2021 (JP) 2021-114882

(51) Int. Cl. F16J 15/54; F16C 33/76

(52) U.S. Cl. CPC F16J 15/54; F16C 33/76; F16C 2326/02

(57) ABSTRACT

A sealing device configured to be mounted on a rolling bearing provided for a wheel bearing device, the wheel bearing device including an axle pipe and a rolling bearing being fitted onto an outer circumferential stepped portion formed on an outer circumference of the axle pipe to rotatably support a wheel, the sealing device being mounted between an outer ring and an inner ring. The sealing device includes a slinger member having a first cylindrical portion, a disk portion, and a second cylindrical portion; a core body member having a cylindrical portion and a disk portion; and a seal body made of an elastic material. An inner circumferential face of a seal body cylindrical portion has an inclined portion constituting a labyrinth of which diameter gradually increases toward one side from the other side in the axial direction between the inner circumferential face and the second cylindrical portion.

### BACKGROUND ART

### Field of the Invention

The disclosure relates to a sealing device configured to be mounted between an outer ring and an inner ring of a wheel bearing device to be fitted onto an outer circumferential stepped portion formed on an outer circumference of an axle pipe through which a drive shaft is inserted along the axial direction.

### Description of the Related Art

In the wheel bearing device, an axle shaft of a full floating type is known in which a drive shaft connected to a differential gear on an internal side of a car body is inserted into an axle pipe. In this case, a rolling bearing is mounted on the outer circumferential stepped portion formed on the outer circumference of the axle pipe. A hub wheel for attaching a wheel is rotatably abutted on the outer ring of the rolling bearing and is connected to a flange of the drive shaft with a bolt or the like. Thus, the driving force of the differential gear is transmitted to the wheel via the hub wheel.

In such a wheel bearing device, the differential oil of the differential gear sometimes reaches the rolling bearing through the axle pipe. Therefore, a sealing device as disclosed in Japanese Unexamined Patent Application No. 2016-084911 is mounted in an annular space between the outer ring and the inner ring of the rolling bearing in order to inhibit the differential oil from entering the inside of the rolling bearing.

### RELATED ART DOCUMENTS

### Patent Documents

### Patent Document 1:

Japanese Unexamined Patent Application Publication No. 2016-084911

### Patent Document 2:

Japanese Unexamined Patent Application Publication No. 2005-240894

### SUMMARY OF THE INVENTION

### Problems to be Solved by the Invention

Since there are problems that contaminants such as iron powder generated by friction of the differential gears may be included in differential oil, a side lip is provided to inhibit the contaminants from being jammed into a dust lip in the sealing device of Japanese Unexamined Patent Application No. 2016-084911. And the side lip inhibits the differential oil containing the contaminants from reaching the dust lip.

However, in the sealing device of Japanese Unexamined Patent Application No. 2016-084911, the differential oil having reached the side lip via a labyrinth structure accumulates between the side lip and the outer ring, and the differential oil may not be effectively discharged out of the sealing device. If the differential oil is not discharged out of the sealing device in such a way, there is a fear that the differential oil may pass through the side lip and reach the dust lip over time.

Japanese Unexamined Patent Application Publication No. 2005-240894 discloses a sealing device having a structure to discharge foreign substances such as muddy water entered an internal space by rotational force. However, Japanese Unexamined Patent Application Publication No. 2016-084911 discloses the sealing device that is mounted on the wheel bearing device fitted onto the outer circumferential stepped portion formed on the outer circumference of the axle pipe. In the sealing device of Japanese Unexamined Patent Application Publication No. 2005-240894, since a slinger member is substantially in the shape of the letter L, the contaminants are jammed into the seal lip when the differential oil enters the slidably contacting portion of the seal lip and the slinger member, thereby application of the sealing device of Japanese Unexamined

Patent Application Publication No. 2005-240894 is difficult. In the sealing device of Japanese Unexamined Patent Application Publication No. 2005-240894, since a labyrinth is not formed between the substantially L-shaped slinger member and a seal body, there is a fear that the discharge effect of foreign substances having entered the internal space may not be sufficiently exhibited even if the rotational force is exerted on the sealing device.

The present invention is proposed in view of the above-mentioned problems and has an object to provide a sealing device capable of inhibiting the entry of differential oil into the rolling bearing and of efficiently discharging the differential oil.

### Means of Solving the Problems

A sealing device is configured to be mounted on a rolling bearing provided for a wheel bearing device, the wheel bearing device including an axle pipe through which a drive shaft is inserted in an axial direction and the rolling bearing rotatably supporting a wheel and being fitted onto an outer circumferential stepped portion formed on an outer circumference of the axle pipe, the rolling bearing including an outer ring and an inner ring opposing each other in a radial direction. The sealing device includes a slinger member having a first cylindrical portion, a disk portion, and a second cylindrical portion, the first cylindrical portion being fitted to an outer circumferential face of the inner ring that is a fixed member, the disk portion extending to an outer diameter side from an end portion on one side in the axial direction of the first cylindrical portion, the second cylindrical portion extending from an end portion on an outer diameter side of the disk portion to an other side in the axial direction. The sealing device includes a core body member having a cylindrical portion and a disk portion, the cylindrical portion being fitted to an inner circumferential face of the outer ring that is a rotatable member, the disk portion extending to an inner diameter side from an end portion on the other side in the axial direction of the cylindrical portion. The sealing device also includes a seal body made of an elastic material, the seal body having a seal body cylindrical portion fixed to an inner circumferential face of the cylindrical portion and a seal lip slidably contacting the slinger member. An inner circumferential face of the seal body cylindrical portion has an inclined portion constituting a labyrinth of which diameter gradually increases toward the one side from the other side in the axial direction between the inner circumferential face of the seal body cylindrical portion and the second cylindrical portion.

### Effect of the Invention

Since the sealing device of an embodiment of the present invention has the configuration described above, the differential oil is inhibited from entering the rolling bearing and is efficiently discharged.

### BRIEF DESCRIPTION OF THE DRAWINGS

FIG. 1 is a schematic longitudinal sectional view diagrammatically illustrating an example of a wheel bearing device in which a sealing device of one embodiment of the present invention is incorporated.

FIG. 2 is a diagrammatic enlarged view of the part X of FIG. 1, and is a diagrammatic longitudinal sectional view of the sealing device of the embodiment of the present invention.

FIG. 3 is a diagrammatic longitudinal sectional view of the sealing device of a modification of the present invention.

FIG. 4A and FIG. 4B are diagrammatic perspective views of the side cross section on one side of the sealing device of the modification of the present invention.

### DETAILED DESCRIPTION

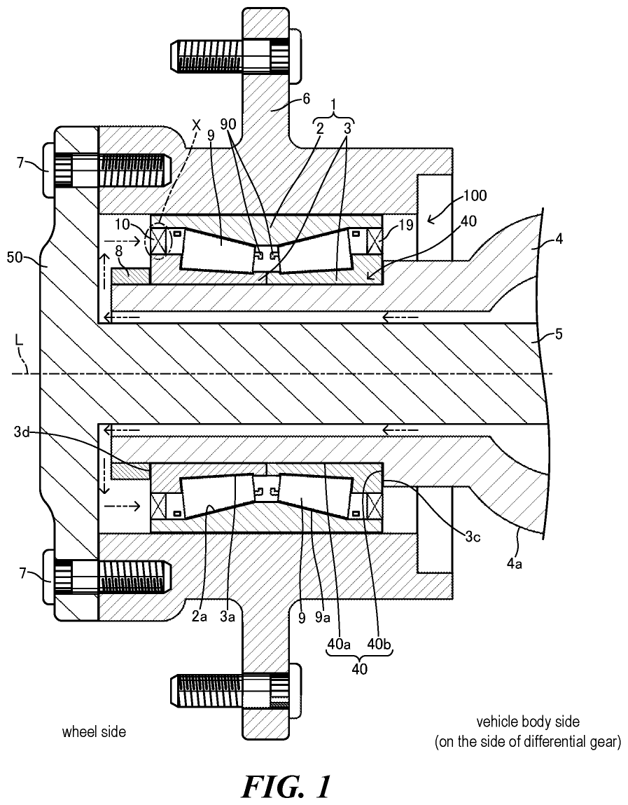

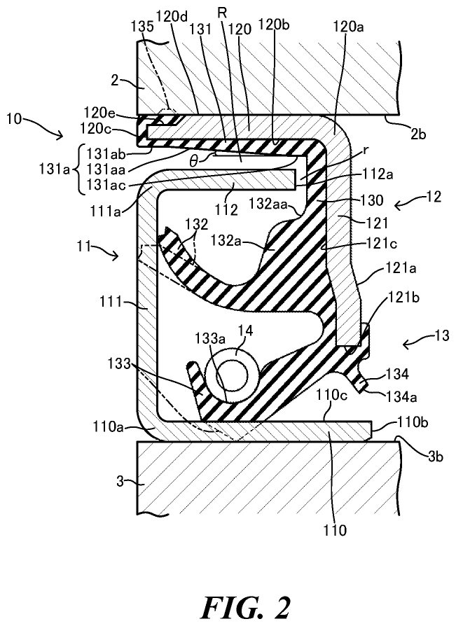

Embodiments of the present invention are described based on the drawings. In some drawings, part of the detailed reference numerals allotted to other figures are omitted. A wheel bearing device 100 illustrated in FIG. 1 includes an axle pipe 4 through which a drive shaft 5 is inserted along the axial direction, and a rolling bearing 1 that is fitted onto an outer circumferential stepped portion 40 formed on an outer circumference 4a of the axle pipe 4 and that supports a wheel rotatably. As illustrated in FIGS. 1 and 2, a sealing device 10 according to the embodiment of the present invention is mounted between an outer ring 2 and an inner ring 3 that constitute the rolling bearing 1 and face each other in the radial direction in the wheel bearing device 100. The sealing device 10 includes a slinger member 11, a core body member 12, and a seal body 13. The slinger member 11 includes a first cylindrical portion 110 to be fitted to an outer circumferential surface 3b of the inner ring 3 that is a fixed member, a disk portion 111 extending to the outer diameter side from an end portion 110a on one side in the axial direction of the first cylindrical portion 110, and a second cylindrical portion 112 extending to the other side in the axial direction from an end portion 111a on the outer diameter side of the disk portion 111. The core body member 12 includes a cylindrical portion 120 to be fitted to an inner circumferential face 2b of the outer ring 2 that is a rotary member, and a disk portion 121 extending to the inner diameter side from an end portion 120a on the other side in the axial direction of the cylindrical portion 120. The seal body 13 is made of an elastic material having a seal body cylindrical portion 131 fixed to an inner circumferential face 120b of the cylindrical portion 120, and seal lips 132 and 133 that slidably contact the slinger member 11. An inner circumferential face 131a of the seal body cylindrical portion 131 includes an inclined portion 131aa that forms a labyrinth R of which diameter gradually increases toward one side from the other side in the axial L direction between the second cylindrical portion 112 and the inner circumferential face 131a.

In the following detailed explanation, the left side is the wheel side and the right side is the internal side of a car body (differential gear side) on the sheet of FIG. 1 and so on, and one side in the axial direction is the wheel side, and the other side in the axial direction is the internal side of the car body (differential gear side) in the followings. Further, the portion indicated by the two-dotted chain line of the seal body 13 shows the original shape before deformation on the drawings.

The sealing device 10 according to one embodiment of the present invention is described with reference to FIGS. 1 and 2.

FIG. 1 illustrates a bearing device to drive a wheel by the drive shaft 5, i.e., an axle shaft, of a full floating type for use in a heavy vehicle such as a truck or a bus, as an example of the wheel bearing device 100 in which the sealing device 10 is mounted. The wheel bearing device 100 includes the axle pipe 4, i.e., an axle housing, through which the drive shaft 5 is inserted, a rolling bearing 1 having a plurality of conical rollers 9, 9, and a hub wheel 6. The hub wheel 6 is connected by a bolt 7 to a flange 50 of the drive shaft 5, and the power of the differential gear is transmitted to the hub wheel 6. Further, with the rolling bearing 1 being fitted into the hub wheel 6, the hub wheel 6 is rotatably supported by the rolling bearing 1. The rolling bearing 1 is fitted into the hub wheel 6 and is fitted onto the outer circumferential stepped portion 40 that is formed at the end portion on the wheel side of the outer circumference 4a of the axle pipe 4 and includes an axial outer circumferential face 40a along the axial direction and a radial outer circumferential face 40b along the radial direction. Specifically, the rolling bearing 1 is fitted onto the outer circumferential stepped portion 40 from the end portion on the wheel side of the axle pipe 4, and is fitted in such a manner that the end face 3c on the internal side of the car body of the inner ring 3 impinges on the radial outer circumferential face 40b of the outer circumferential stepped portion 40, and in such a state, the rolling bearing 1 is fastened to be fixed to an end portion 3d on the wheel side of the inner ring 3 by a fixing member 8. The full floating type shaft as illustrated in FIG. 1 is configured such that the wheel is attached to the axle pipe 4 by the hub wheel 6 and the rolling bearing 1, the load applied to the drive shaft 5 is dispersed since and the load of the car is supported by the axle pipe 4, and the drive shaft 5 is removable irrespective of the wheel. In the inspection and maintenance to check twist and crack of the drive shaft 5, the drive shaft 5 is capable of being taken out and removed by removing the bolt 7. Further, for replacing and inspecting the rolling bearing 1, the rolling bearing 1 is removable from the axle pipe 4 when the bolt 7 and the fixed member 8 are removed.

The rolling bearing 1 includes the outer ring 2, a pair of inner rings 3, 3, a plurality of conical rollers 9, 9 arranged as rolling bodies, holders 90, 90 holding the conical rollers 9, 9, and sealing devices 10, 19 to seal a space between the outer ring 2 and the inner rings 3, 3. The outer ring 2, a pair of inner rings 3,3, and a plurality of conical rollers 9,9 are made of metal materials, and the plurality of conical rollers 9,9 held in the holders 90, 90 are interposed so as to be able to rotate a truck wheel 2a of the outer ring 2 and truck wheels 3a, 3a of the inner rings 3.

In the wheel bearing device 100 having such a structure, the differential oil flows to the inside of the flange 50 along the space between the outer circumference of the drive shaft 5 and the inner circumference of the axle pipe 4 by the centrifugal force or the like caused when the vehicle turns, as illustrated by the arrow of the two-dotted chain line in FIG. 1. Therefore, the sealing device 10 is provided to prevent the differential oil from entering the internal space of the rolling bearing 1 from the wheel side of the rolling bearing 1. In addition, since the differential oil flows not only to the wheel side but also to the fitting region between the inner rings 3, 3 and the axle pipe 4 and enters the internal side of the car body, the sealing device 19 is also provided on the internal side of the car body of the rolling bearing 1. The sealing devices 10, 19 function not only for preventing entry of differential oil but also for preventing outside leakage of grease sealed in the bearing of the rolling bearing 1 and preventing entry of muddy water from the outside.

Here, the differential oil refers to oil which is used for smoothly driving the differential gear, and which requires to be filled with a predetermined amount or replenished periodically. The sealing device 10 of the embodiment of the present invention to be described below is a sealing device to be provided at the end portion on the wheel side of the rolling bearing 1, but such a configuration can be applied to the sealing device 19 to be provided at the end portion on the internal side of the car body of the rolling bearing 1.

The sealing device 10 of the embodiment of the present invention illustrated in FIG. 2, which is an enlarged view of the portion X of FIG. 1, includes the slinger member 11, the core body member 12, and the seal body 13. The slinger member 11 is formed by pressing a steel plate such as SPCC or SUS, and is a cylindrical body of which longitudinal section on one side is substantially an inverted U-shape as illustrated in FIG. 2. The slinger member 11 includes the first cylindrical portion 110 to be fitted to the outer circumferential face 3b of the inner ring 3 and the disk portion 111 extending from the end portion 110a on the wheel side of the first cylindrical portion 110 to the outer diameter side. Furthermore, in addition to the first cylindrical portion 110 and the disk portion 111, the slinger member 11 includes the second cylindrical portion 112 extending from the end portion 111a on the outer diameter side of the disk portion 111 to the internal side of the car body. The second cylindrical portion 112 is bent by about 90 degrees from the end portion 111a on the outer diameter side of the disk portion 111 and is formed substantially parallel to the first cylindrical portion 110. The end portion 110b on the internal side of the car body of the first cylindrical portion 110 extends to the internal side of the car body further than the end portion 112a on the internal side of the car body of the second cylindrical portion 112, and is provided at the substantially same position of the tip end 134a of the grease lip 134 of the seal body 13 to be explained later. A gap “r” extending in the radial direction and communicating with the labyrinth R to be mentioned later is formed between the end portion 112a on the internal side of the car body of the second cylindrical portion 112 and a seal body base portion 130 of the seal body 13 to be described later that oppose in the axial direction.

The core body member 12 is formed by pressing a steel plate such as SPCC or SUS, and is formed in a cylindrical shape of which longitudinal section on one side is substantially an inverted L-shape as shown in FIG. 2. The core body member 12 includes the cylindrical portion 120 to be fitted to the inner circumferential face 2b of the outer ring 2 and the disk portion 121 extending from the end portion 120a on the internal side of the car body of the cylindrical portion 120 to the inner diameter side. A recessed portion 120e which is recessed into the inner diameter side is provided on the wheel side face of the outer circumferential face 120d of the cylindrical portion 120.

The seal body 13 is constituted with an elastic member such as a rubber material, and is fixed and integrated into the core body member 12 via the seal body base portion 130 by vulcanization molding. The seal body base portion 130 covers the face on the inner diameter side of a face 121a on the internal side of the car body of the disk portion 121 of the core body member 12, wraps around an end portion 121b on the inner diameter side of the disk portion 121, and entirely covers a face 121c on the wheel side of the disk portion 121. Further, the seal body base portion 130 covers the entire of the inner circumferential face 120b of the cylindrical portion 120 of the core body member 12, wraps around the end portion 120c on the wheel side of the cylindrical portion 120, and reaches the recessed portion 120e of the outer circumferential face 120d of the cylindrical portion 120. In such a way, the seal body 13 is fixed and integrated into the core body member 12.

The seal body 13 includes the seal body cylindrical portion 131 fixed to the inner circumferential face 120b of the cylindrical portion 120 of the core body member 12, the first seal lip 132 that slidably contacts the disk portion 111 of the slinger member 11, and the second seal lip 133 that slidably contacts the first cylindrical portion 110 of the slinger member 11. Further, the seal body 13 includes a grease lip 134 that does not come into contact with the slinger member 11, a tip end 134a of the grease lip 134 extending to the inner diameter side in the radial direction and toward the internal space side of the rolling bearing 1. A portion of the seal body base portion 130 covering the entire inner circumferential face 120b of the cylindrical portion 120 of the core body member 12 constitutes the seal body cylindrical portion 131.

The first seal lip 132 is a side lip extending to the wheel side, the diameter gradually expands toward the wheel side, and the distal end portion is directed to the outer diameter side. The base portion 132a (the root portion) of the first seal lip 132 is formed so as to be raised toward the outer diameter side, to become thicker than other portions, and to expand in the shape of a mountain when seen in the cross section, and the border line raised from the seal body base portion 130 constitutes a stepped portion 132aa. The second seal lip 133 is a side lip extending to the wheel side, the diameter is gradually reduced toward the wheel side, and the tip end portion is directed to the inner diameter side. The second seal lip 133 includes an annular recessed portion 133a which is raised into the inner diameter side on the face on the outer diameter side. An annular spring 14 in which a coil spring is connected annularly is mounted on the annular recessed portion 133a. By the annular spring 14, the second seal lip 133 is pressed into the inner circumferential face 110c of the first cylindrical portion 110 of the slinger member 11, so that the sealing performance is improved.

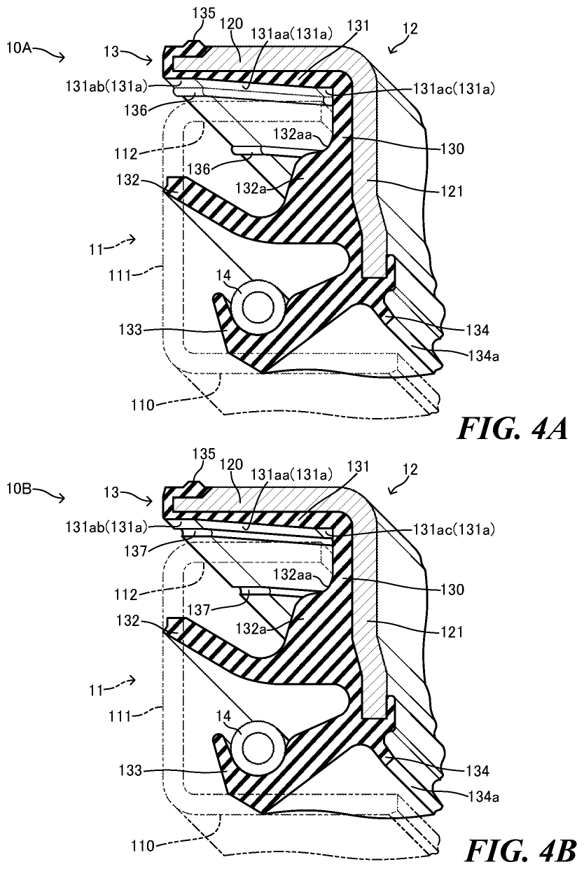

The inner circumferential face 131a of the seal body cylindrical portion 131 includes an inclined portion 131aa that inclines at an angle θ from the other side to one side relative to the shaft L, that is, in the embodiment of FIG. 2, from the internal side of the bearing to the wheel side. The labyrinth R of which diameter gradually increases from the internal side of the bearing toward the wheel side is formed between the inclined portion 131aa and the second cylindrical portion 112. A face 131ab on the wheel side and a face 131ac on the internal side of the bearing which interpose the inclined portion 131a are configured to be flat faces, referring to FIG. 4A and the like, but the inner circumferential face 131a of the seal body cylindrical portion 131 can be constituted only with the inclined portion 131aa.

In the seal body 13, an annular protruding portion 135 that rises on the outer diameter side is formed at the portion of the core body member 12 that reaches the recessed portion 120e. The annular protruding portion 135 is formed so as to interpose in a compressed state between the inner circumferential face 2b of the outer ring 2 and the recessed portion 120e of the cylindrical portion 120 of the core body member 12 when the core body member 12 is fitted into the outer ring 2. By interposing the annular protruding portion 135 in a compressed state between the outer ring 2 and the recessed portion 120e of the core body member 12, the differential of or the like is inhibited from entering the fitting region of the inner circumferential face 2b of the outer ring 2 and the outer circumferential face 120d of the core body member 12.

In the sealing device 10 according to the embodiment of the present invention, it is characterized in that a sealing device having a U-shaped slinger member 11 is applied to the wheel bearing device 100. In addition to the above, it is configured that the diameter of the inner circumferential face 131a increases and the diameter of the labyrinth R gradually increases from the internal side of the bearing toward the wheel side between the inner circumferential face 131a of the seal body cylindrical portion 131 and the second cylindrical portion 112. Therefore, since the size of the gap of the labyrinth R gradually decreases from the wheel side toward the internal space of the bearing, it is difficult for the differential oil or the like to enter, pass through the labyrinth R and reach the gap “r”. Since the labyrinth R is configured such that the diameter gradually increases toward the wheel side by the inclined portion 131aa and the second cylindrical portion 112, the entered differential oil is easily discharged from the inside of the sealing device 10 along the inclined portion 131aa by the centrifugal force acting on the sealing device 10 as the drive shaft 5 rotates around the shaft L. Therefore, the amount of differential oil that enters the slidably contacting region of the first seal lip 132 and the second seal lip 133 with the slinger member 11 is inhibited. As a result, since the abrasion wear of the slidably contact region of the first seal lip 132 and the second seal lip 133 is inhibited, change in the contact state with the slinger member 11 is also inhibited.

The angle θ of the inclined portion 131aa is preferably about 2 to 8 degrees, and the angle θ is about 4 degrees in the embodiment of the present invention. Being configured at such an angle, the length of the inclined portion 131aa in the axial direction is sufficiently secured while keeping the discharging effect of the differential oil entered the sealing device 10. When the angle θ of the inclined portion 131aa is less than 2 degrees, it is almost the same as the case with no inclination, and the discharge effect of the differential oil entered the sealing device 10 tends not to be expectable. Further, when the angle θ of the inclined portion 131aa is greater than 8 degrees, the thickness of the seal body cylindrical portion 131 gradually increases toward the gap “r” side, and the labyrinth R between the second cylindrical portion 112 and the seal body cylindrical portion 131 becomes too narrow to discharge the differential oil.

Further, according to the sealing device 10 of the embodiment of the present invention, in addition to the configuration of the inclined portion 131aa, the labyrinth R, and the gap “r”, the base portion 132a of the first seal lip 132 is largely raised to form the shape of a mountain. Therefore, such a configuration further reduces the amount of differential oil or the like that reaches the slidably contacting regions of the first seal lip 132 and the second seal lip 133 and that reaches the inside of the bearing of the rolling bearing 1. Therefore, jamming of contaminants contained in the differential oil and the abrasion wear of the slidably contacting portion are inhibited, and the life of the sealing device 10 is extended.

### Modified Embodiment

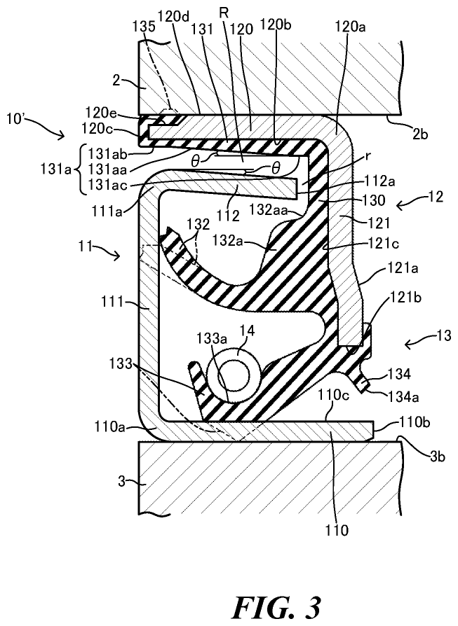

Next, the modified embodiments illustrated in FIGS. 3 and 4 are described. The explanation of the effects and the configuration of the portions common to those of the sealing device 10 in the embodiment shown in FIGS. 1 and 2 are omitted.

A sealing device 10′ of FIG. 3 is different in the configuration of the second cylindrical portion 112 of the slinger member 11 from that of the above-mentioned embodiment. The second cylindrical portion 112 of the slinger member 11 in the sealing device 10′ of FIG. 3 inclines such that the diameter gradually decreases toward the inner diameter side at an angle θ from the wheel side toward the internal side of the bearing. It is preferable that the angle θ be substantially the same as the inclined angle θ of the inclined portion 131aa of the inner circumferential face 131a of the seal body cylindrical portion 131 of the seal body 13, and the angle θ is about 4 degrees in this modification. Thus, having such a configuration that the inclined portion 131aa and the second cylindrical portion 112 incline in a substantially parallel manner, the size of the gap of the labyrinth R extending in the axial direction is substantially constant. Therefore, with the configuration which prevents entering of the differential oil or the like by the effect of the labyrinth R and the gap “r”, the differential oil is easily guided to the inclined region to be easily discharged even if the differential oil enters.

The angle θ of the inclined portion 131a is not always required to be the same as the angle θ of the second cylindrical portion 112 of the slinger member 11 as mentioned above and the angle θ is preferably about 2 to 8 degrees as mentioned in the above embodiment. For example, the angle θ of the second cylindrical portion 112 can be 3 degrees and the angle θ of the inclined portion 131a can be 8 degrees. Further, the second cylindrical portion 112 is not limited to incline such that the diameter gradually decreases to the inner diameter side toward the internal side of the bearing from the wheel side. The diameter of the second cylindrical portion 112 can incline such that the diameter gradually increases toward the internal side of the bearing from the wheel side. In such a case, as the size of the gap of the labyrinth R gradually decreases from the wheel side toward the internal space of the bearing, so that the differential oil or the like has difficulty to enter the labyrinth R.

Next, the modified embodiments illustrated in FIGS. 4A and 4B are described. In the modifications of FIGS. 4A and 4B, the configuration of the inner circumferential face 131a of the seal body cylindrical portion 131 of the seal body 13 is different from that of the above embodiment. In FIGS. 4A and 4B, the slinger member 11 is illustrated by a two-dotted chain line for explaining the inner circumferential face 131a, but the sealing devices 10A, 10B in FIGS. 4A and 4B include the slinger member 11.

The inner circumferential face 131a of the seal body cylindrical portion 131 of the seal body 13 of a sealing device 10A of FIG. 4A includes a protruding portion 136 extending along the axial direction and protruding to the inner diameter side. The cross section of the protruding portion 136 is a semicircular shape, and a plurality of protruding portions 136 are formed side by side at appropriate intervals in the circumferential direction.

According to the sealing device 10A, even if the differential oil or the like enters the labyrinth R, the protruding portion 136 inhibits the spread of the differential oil into the inner circumferential face 131a in the circumferential direction, and the differential oil stays between the adjacent protruding portions 136. Then, rotating the wheel bearing device 100, the differential oil remaining between the protruding portions 136, 136 is efficiently discharged out of the sealing device 10A by the centrifugal force acting on the sealing device 10A.

A plurality of groove portions 137 extending along the axial direction and recessing toward the outer diameter side are formed in the circumferential direction on the inner circumferential face 131a of the seal body cylindrical portion 131 of the seal body 13 of a sealing device 10B in FIG. 4B. The groove of the grooved portion 137 is formed by recessing in a semicircular shape. According to the sealing device 10B, even if the differential oil or the like enters the labyrinth R, the spread of the differential oil into the inner circumferential face 131a in the circumferential direction is inhibited by the grooved portion 137, and the differential oil stays in the grooved portion 137. Then, rotating the wheel bearing device 100, the differential oil remaining in the groove portion 137 is efficiently discharged out of the sealing device 10B by the centrifugal force acting on the sealing device 10B.

In the modified embodiments of FIGS. 4A and 4B, the second cylindrical portion 112 of the slinger member 11 is substantially parallel to the shaft L like the above-mentioned embodiment. However, the embodiment is not limited to such a configuration, and the second cylindrical portion 112 can be configured to incline so as to be substantially parallel to the inclined portion 131aa in the same manner as the sealing device 10′ of FIG. 3. Further, the shapes and the spacing of the protruding portion 136 and the groove portion 137 can be appropriately designed without being limited to the illustrations in the figures. Further, the protruding portion 136 and the groove portion 137 can be alternately formed in plural manners in the circumferential direction.

The configurations of the sealing devices 10, 10′, 10A, and 10B of each embodiment mentioned above are not limited to the shape and configuration in the figures, and can be appropriately designed. Further, the slinger member 11 and the core body member 12 are not limited to be made of steel plate as mentioned above, and can be made of other materials such as metal material or resin material. Furthermore, the shape and the number of the seal lips provided for the seal body 13 are not limited to those illustrated in the figures. In the above embodiment, the inclined portion 131aa is explained based on the sealing device 10 illustrated in FIG. 2, but when a similar structure is applied to the sealing device 19, the labyrinth R of which diameter gradually increases from the internal side of the bearing toward the internal side of the car body is formed and the inclined portion which inclines at an angle θ on the outer diameter side is applied.

### DESCRIPTION OF THE REFERENCE NUMERAL

1 rolling bearing
100 wheel bearing device
2 outer ring
2b inner circumferential face
3 inner ring
3b outer circumferential face
4 axle pipe
4a outer circumference
40 outer circumferential stepped portion
5 drive shaft
10,10′,10A, 10B sealing device
11 slinger member
110 first cylindrical portion
110a end portion on one side in the axial direction (end portion on wheel side)
111 disk portion
111a end portion on outer diameter side
112 second cylindrical portion
12 core body member
120 cylindrical portion
120a end portion on other side in the axial direction (end portion on internal side of car body)
121 disk portion
13 seal body
131 seal body cylindrical portion
131a inner circumferential face
131aa inclined portion
132 first seal lip
133 second seal lip
134 grease lip
134a tip end
136 protruding portion
137 groove portion
R labyrinth

1. A sealing device configured to be mounted on a rolling bearing provided for a wheel bearing device, the wheel bearing device comprising an axle pipe through which a drive shaft is inserted in an axial direction and the rolling bearing rotatably supporting a wheel and being fitted onto an outer circumferential stepped portion formed on an outer circumference of the axle pipe, the rolling bearing comprising an outer ring and an inner ring opposing each other in a radial direction,
the sealing device comprising:
a slinger member comprising a first cylindrical portion, a disk portion, and a second cylindrical portion, the first cylindrical portion being fitted to an outer circumferential face of the inner ring that is a fixed member, the disk portion extending to an outer diameter side from an end portion on one side in the axial direction of the first cylindrical portion, the second cylindrical portion extending from an end portion on an outer diameter side of the disk portion to an other side in the axial direction;
a core body member comprising a cylindrical portion and a disk portion, the cylindrical portion being fitted to an inner circumferential face of the outer ring that is a rotatable member, the disk portion extending to an inner diameter side from an end portion on the other side in the axial direction of the cylindrical portion; and
a seal body made of an elastic material, the seal body comprising a seal body cylindrical portion fixed to an inner circumferential face of the cylindrical portion and a seal lip slidably contacting the slinger member,
wherein an inner circumferential face of the seal body cylindrical portion has an inclined portion constituting a labyrinth of which diameter gradually increases toward the one side from the other side in the axial direction between the inner circumferential face of the seal body cylindrical portion and the second cylindrical portion.

2. The sealing device according to claim 1, wherein the seal body comprises a first seal lip slidably contacting the disk portion of the slinger member and a second seal lip slidably contacting the first cylindrical portion.

3. The sealing device according to claim 1, wherein the seal body comprises a grease lip of which tip end extends to an inner diameter side in the radial direction and to an internal space side of the rolling bearing, the grease lip not contacting the slinger member.

4. The sealing device according to claim 1, wherein the second cylindrical portion is configured to incline so as to be parallel with the inclined portion.

5. The sealing device according to claim 1, wherein a plurality of protruding portions are provided on the inner circumferential face of the seal body cylindrical portion, the protruding portions extending along the axial direction and protruding to inner diameter side.

6. The sealing device according to claim 1, wherein a plurality of groove portions are provided on the inner circumferential face of the seal body cylindrical portion, the groove portions extending along the axial direction and being concave into outer diameter side.

7. The sealing device according to claim 2, wherein the seal body comprises a grease lip of which tip end extends to an inner diameter side in the radial direction and to an internal space side of the rolling bearing, the grease lip not contacting the slinger member.

8. The sealing device according to claim 2, wherein the second cylindrical portion is configured to incline so as to be parallel with the inclined portion.

9. The sealing device according to claim 3, wherein the second cylindrical portion is configured to incline so as to be parallel with the inclined portion.

10. The sealing device according to claim 2, wherein a plurality of protruding portions are provided on the inner circumferential face of the seal body cylindrical portion, the protruding portions extending along the axial direction and protruding to inner diameter side.

11. The sealing device according to claim 3, wherein a plurality of protruding portions are provided on the inner circumferential face of the seal body cylindrical portion, the protruding portions extending along the axial direction and protruding to inner diameter side.

12. The sealing device according to claim 4, wherein a plurality of protruding portions are provided on the inner circumferential face of the seal body cylindrical portion, the protruding portions extending along the axial direction and protruding to inner diameter side.

13. The sealing device according to claim 2, wherein a plurality of groove portions are provided on the inner circumferential face of the seal body cylindrical portion, the groove portions extending along the axial direction and being concave into outer diameter side.

14. The sealing device according to claim 3, wherein a plurality of groove portions are provided on the inner circumferential face of the seal body cylindrical portion, the groove portions extending along the axial direction and being concave into outer diameter side.

15. The sealing device according to claim 4, wherein a plurality of groove portions are provided on the inner circumferential face of the seal body cylindrical portion, the groove portions extending along the axial direction and being concave into outer diameter side.

16. The sealing device according to claim 5, wherein a plurality of groove portions are provided on the inner circumferential face of the seal body cylindrical portion, the groove portions extending along the axial direction and being concave into outer diameter side.
